(19) United States
(12) Patent Application Publication
(10) Pub. No.: US 2014/0252781 A1
(43) Pub. Date: Sep. 11, 2014

(54) DEVICE FOR UNLOCKING A DOOR

(71) Applicant: Frans J.R. Vanderick, Halen (BE)

(72) Inventor: Frans J.R. Vanderick, Halen (BE)

(21) Appl. No.: 14/349,715

(22) PCT Filed: Aug. 8, 2012
(86) PCT No.: PCT/BE2012/000040

§ 371 Date: May 14, 2014

(30) Foreign Application Priority Data
Oct. 5, 2011 (BE) 2011/0582

(51) Int. Cl. E05C 1/08

(52) U.S. Cl. CPC E05C 1/08
USPC 292/164; 292/143

(57) ABSTRACT

Device for unlocking a door, comprising at least one operating element; a bolt; a coupling which can be placed in the door and which is coupled between the bolt and the operating element, wherein the coupling comprises a pair of scissor arms mounted rotatably around a fixed shaft, and a pair of pivot arms, wherein each pivot arm is connected at a first end for pivoting around a first shaft to a scissor arm and connected at a second end for pivoting around a second shaft to a push part intended to engage against the bolt, such that a tilting of the operating element brings about a movement of the push part, and thus of the bolt.

The present invention relates to a device for unlocking a door, comprising at least one operating element which can be employed by a user for the purpose of opening the door, a bolt movable between a locking position and an opening position of the door, and a coupling which can be placed in the door and which is coupled between the bolt and the operating element for causing a movement of the bolt from the locking position to the opening position upon activation of an operating element.

Such a device is for instance known from EP 1 741 858 A1 in the name of applicant. Inside doors are typically equipped with a spring-mounted bolt which can be moved from a locking position to an opening position by means of a doorhandle. Doors are further available on the market which are provided with a press element which is electronically connected to a locking element such that the door can be opened by simply pressing a button.

The present invention has for its object to provide a simple and robust device of the type stated in the preamble which can be fitted better into an inside door, in particular a door of a limited thickness, as an alternative to a doorhandle.

For this purpose an embodiment of the device according to the invention is distinguished in that the coupling comprises a pair of scissor arms mounted rotatably around a fixed shaft and a pair of pivot arms. Each pivot arm is connected at a first end for pivoting around a respective first shaft to a corresponding scissor arm and connected at a second end for pivoting around a second shaft to a push part intended to engage against the bolt. The fixed shaft and first and second shafts are parallel and are intended to extend in a plane substantially parallel to the door, this such that a tilting of the operating element brings about a movement of the push part, which movement of the push part brings about a movement of the bolt.

Through the use of such scissor arms and pivot arms a very slender device can be obtained by moving the scissor arms (and so also the pivot arms) toward each other. In this extended position the device can be easily inserted and fitted into a recess in the door, even if the door is relatively thin.

Further developed possible embodiments are described in the appended dependent claims.

According to an advantageous embodiment, the device further comprises a housing which is intended for insertion into a recess in the door, wherein the fixed shaft is fixedly mounted in the housing and the second shaft is mounted for movement in a guide in the housing. This guide can for instance be formed by a recess in the housing.

According to an advantageous embodiment, each operating element takes the form of a flap positioned pivotally on one side in the housing. The flap preferably extends in a plane substantially parallel to the fixed shaft and the first and second shafts and is tiltable in the direction of these shafts.

According to another aspect of the invention, a device is provided comprising at least one operating element, a bolt movable between a locking position and an opening position of the door, and a coupling which can be placed in the door and which is coupled between the bolt and the operating element for causing a movement of the bolt from the locking position to the opening position upon activation of an operating element, wherein the at least one operating element comprises a first operating element and a second operating element which extend on either side of the coupling and are intended to be built into opposite sides of the door. The first operating element is tiltable around a first tilting shaft and the second operating element is tiltable around a second tilting shaft parallel to the first tilting shaft, the first and second tilting shafts being spring-mounted relative to each other, this such that these tilting shafts are movable toward each other during placing of the device in the door and can move with spring action away from each other for the purpose of positioning the device in the door. The device can in this way be positioned in simple manner in a recess in a door.

According to an advantageous embodiment hereof, the first and the second operating element are each connected by means of a spring-mounted arm to a housing in which the coupling is received. These spring-mounted arms can for instance be resiliently suspended from a fixed shaft intended for placing parallel to the plane of the door.

According to an embodiment, the invention provides an assembly which consists of three parts and which co-acts in moving a mechanism, such as a lock of a door, out of the locked position. The pressing/pulling movement of a user is converted in effective manner into a scissor movement of the coupling and a movement of the bolt. The bolt is preferably tiltable, but can also be slidable. The tilting movement of the coupling element is then converted to a sliding movement.

The operating element preferably operates the coupling through a direct coupling. A pushing movement results in a tilting of the operating element and thus in a scissor movement of the coupling.

Other features and advantages will become apparent from the description of a number of non-limitative exemplary embodiments with reference to the accompanying drawings, in which:

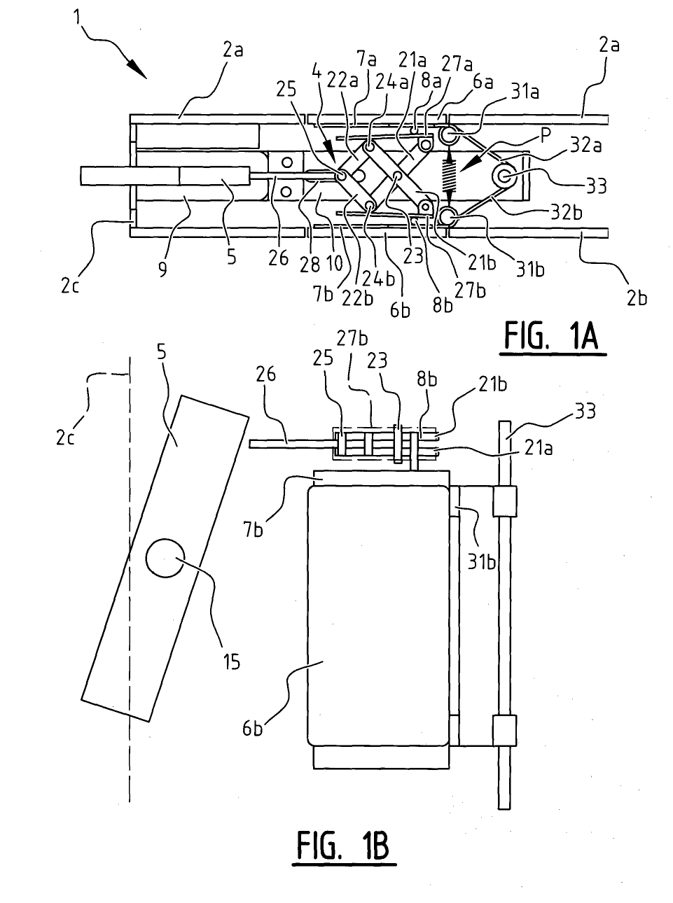

FIGS. 1A and 1B show schematically respectively a top view and a cross-section of a first embodiment of a device according to the invention in the locking position;

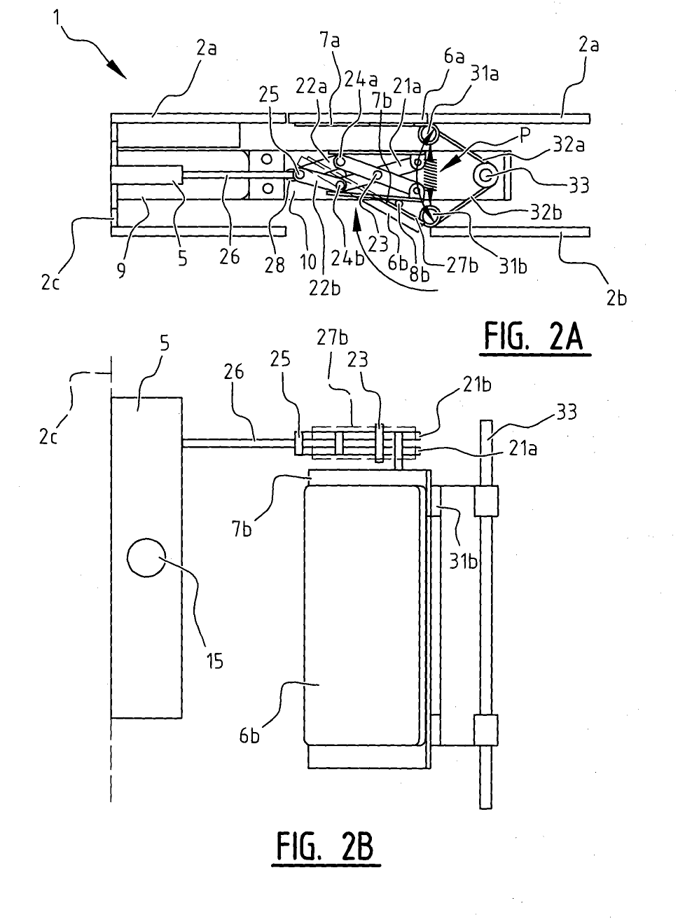

FIGS. 2A and 2B show schematically respectively a top view and a cross-section of the first embodiment of FIG. 1 in the activated position of an operating element.

FIGS. 1A-B and 2A-B show a door 1 with a first wall 2a, an opposite second wall 2b and a side wall 2c. Arranged in door 1 is a first embodiment of a device according to the invention. An operating element 3a, 3b is built into each wall 2a, 2b of the door, although it is also possible to provide an operating element in only one wall.

The device has a frame which is formed here for instance by a first housing 9 for a bolt 5 and a second housing 10 for a coupling 4 for coupling the operating element 3a, 3b to bolt 5. The diverse shafts for tilting and/or spring means for biasing can be mounted in housing 10. Housing 10 with coupling 4 and operating elements 3a, 3b can be placed integrally in a lock opening of door 1. Only the outer flaps 6a, 6b of operating elements 3a, 3b are typically placed later, i.e. after insertion of housing 10 with inner flap 7a, 7b. Note in this respect that outer flap 6a, 6b is typically dimensioned to fit into a recess of the door, while inner flap 7a, 7b is typically dimensioned to be larger than the recess in the door such that it supports against an inner side of wall 2a, 2b of the door.

Coupling 4 comprises a pair of scissor arms 21a, 21b mounted rotatably around a fixed shaft 23 and a pair of pivot arms 22a, 22b. Each pivot arm 22a, 22b is connected at a first end for pivoting around a corresponding first shaft 24a, 24b to a corresponding scissor arm 21a, 21b and is connected at a second end for pivoting around a second shaft 25 to a push part, here in the form of a pin 26. Note that the second shaft is common here to pivot arms 22a and 22b, but that it would also be possible to connect pivot arm 22a around a second shaft to the push part and to connect pivot arm 22b around another parallel second shaft to the push part. Push pin 26 is intended to engage against bolt 5. Fixed shaft 23 and the first and second pivot shafts 24a, 24b, 25 are parallel and extend in a plane substantially parallel to door 1. A tilting of an operating element 3a, 3b will thus bring about a movement of push part 26 which in turn brings about a movement of the bolt, see FIGS. 2A-B. The use of scissor arms 21a,21b and pivot arms 22a,22b has the advantage that the coupling is very slender when the scissor arms are moved toward each other, whereby coupling 4 can be inserted in doors of a limited thickness.

Fixed shaft 23 is mounted fixedly in housing 10, and second shaft 25 is guided in a guide in the form of a slot-like opening 28 in housing 10.

Operating element 3a, 3b takes the form here of a flap which is mounted in the plane of the door and which is built into the door for pivoting around a tilting shaft 31a, 31b parallel to the plane of the door. Each operating element is more particularly suspended pivotally on one side from the housing and formed from an inner flap 7a, 7b and an outer flap 6a, 6b which extend in a plane substantially parallel to fixed shaft 23 and the first and second pivot shafts 24a, 24b, 25.

The first operating element is tiltable around a first tilting shaft 31a and the second operating element is tiltable around a second tilting shaft 31b which is parallel to the first tilting shaft. The first and second tilting shafts are spring-mounted relative to each other, see the schematic arrow P in FIG. 1A. These tilting shafts are in this way movable toward each other during placing of the device in the door and can move with spring action away from each other for the purpose of positioning the device in the door. This can for instance be realized by connecting each of the first and the second operating element by means of a spring-mounted arm 32a, 32b to the housing. These arms 32a, 32b can for instance be spring-mounted around a fixed shaft 33 arranged in housing 10. Note that fixed shaft 33 could also be situated on the other side of tilting shafts 31a, 31b, close to fixed shaft 23, in order to thus obtain an even more compact device.

Each operating element 3a, 3b is provided with a respective pin 8a, 8b which co-acts with a press plate 27a, 27b. Pin 8a, 8b is arranged such that activation of the operating mechanism carries the coupling 4 from a rest position to an activated position, wherein scissor arms 21a, 21b move toward each other and pivot arms 22a, 22b move toward each other such that push part 26 moves in the direction of bolt 5. Each scissor arm 21a, 21b is connected at a first end to the first end of the respective pivot arm 22a, 22b and is pivotally connected at a second end to press plate 27a, 27b, wherein in the activated position the operating mechanism engages against this press plate in order to move the scissor arms toward each other.

In the shown embodiment the operating element is a push element. The user can unlock the door by pushing against flap 3a, 3b, for instance by hand. The door can here also be pulled/opened toward the user. Displacing the flap 3a, 3b in fact creates a handgrip which is not visible in the starting position.

The operation of the mechanism will now be briefly elucidated. In FIGS. 1A-B the system is at rest. The door is closed because bolt 5 hooks into a lock plate (not shown). When flap 3a is pressed in with the hand as shown in FIGS. 2A-B, this operation causes scissor arms 21a, 21b to move toward each other, whereby push part 26 moves in the direction of bolt 5 and thus moves it into the opening position, whereby door 1 is unlocked.

There can be a coupling between bolt 5 and coupling 4, whereby the bolt is held in the locked position, for instance by means of spring means or a magnet. The spring means can be arranged at various positions, for instance also between operating elements 3a and 3b. Elements 3a, 3b, 4 and 5 are hereby held in the locked position.

In a possible embodiment the bolt takes a sloping form so that it can tilt from the locked position when the door is moved from an opened position to the closed position. The bolt will not then block the closing but will move independently to the unlocked position, whereby the door can be closed. Immediately after closing, the bias will move the bolt back to the locking position and the bolt drops into the lock plate (not shown).

The invention is not limited to the exemplary embodiments illustrated above, and the skilled person will appreciate that many modifications can be envisaged without departing from the scope of the invention, this scope being defined solely by the following claims.

1. Device for locking a door, comprising:
at least one operating element which is intended to be accessible to a user for the purpose of opening the door and which is mounted tiltably relative to the door;
a bolt movable between a locking position and an opening position of the door;
a coupling which can be placed in the door and which is coupled between the bolt and the operating element for causing a movement of the bolt from the locking position to the opening position upon activation of an operating element of the at least one operating element, wherein the coupling comprises a pair of scissor arms mounted rotatably around a fixed shaft, and a pair of pivot arms, wherein each pivot arm is connected at a first end for pivoting around a respective first shaft to a respective scissor arm and connected at a second end for pivoting around a second shaft to a push part intended to engage against the bolt, which fixed shaft and first and second shafts are parallel and are intended to extend in a plane substantially parallel to the door, this such that a tilting of the operating element brings about a movement of the push part, which movement of the push part brings about a movement of the bolt.

2. Device as claimed in claim 1, wherein the device further comprises a housing, which housing is intended for insertion into a recess in the door, wherein the fixed shaft is fixedly mounted in the housing and the second shaft is mounted for movement in a guide in the housing.

3. Device as claimed in claim 1, wherein each operating element takes the form of a flap suspended pivotally on one side from the housing, which flap extends in a plane substantially parallel to the fixed shaft and the first and second shafts.

4. Device as claimed in claim 1, wherein the at least one operating element comprises a first operating element and a second operating element, which operating elements extend on either side of the coupling and are intended to be built into opposite sides of the door.

5. Device as claimed in claim 4, wherein the first operating element is tiltable around a first tilting shaft and wherein the second operating element is tiltable around a second tilting shaft parallel to the first tilting shaft, the first and second tilting shafts being spring-mounted relative to each other, this such that these tilting shafts are movable toward each other during placing of the device in the door and can move with spring action away from each other for the purpose of positioning the device in the door.

6. Device as claimed in claim 4, further comprising a housing, which housing is intended for insertion into a recess in the door, wherein the fixed shaft is fixedly mounted in the housing and the second shaft is mounted for movement in a guide in the housing, and wherein the first and the second operating elements are each connected by means of a spring-mounted arm to the housing.

7. Device as claimed in claim 6, wherein each spring-mounted arm is connected to a second fixed shaft which is parallel to the fixed shaft around which the pair of scissor arms rotate.

8. Device as claimed in claim 1, wherein the scissor arms are spring-mounted relative to each other such that the spring action moves the scissor arms away from each other.

9. Device as claimed in claim 1, wherein a spring means is provided for the purpose of holding the bolt in the locking position.

10. Device as claimed in claim 1, wherein each operating mechanism is provided with a pin which is arranged such that activation of the operating mechanism carries the coupling from a rest position to an activated position, wherein the scissor arms move toward each other and the pivot arms move toward each other such that the push part moves in the direction of the bolt.

11. Device as claimed in claim 1, wherein each scissor arm is connected at a first end to the first end of the respective pivot arm and is connected at a second end to a press plate, wherein in the activated position the operating mechanism engages against this press plate in order to move the scissor arms toward each other.

12. Device for locking a door, comprising:
at least one operating element which is intended to be accessible to a user for the purpose of opening the door and which is mounted tiltably relative to the door;
a bolt movable between a locking position and an opening position of the door:
a coupling which can be placed in the door and which is coupled between the bolt and the operating element for causing a movement of the bolt from the locking position to the opening position upon activation of an operating element of the at least one operating element, wherein the coupling comprises a pair of scissor arms mounted rotatably around a fixed shaft, and a pair of pivot arms, wherein each pivot arm is connected at a first end for pivoting around a respective first shaft to a respective scissor arm and connected at a second end for pivoting around a second shaft to a push part intended to engage against the bolt, which fixed shaft and first and second shafts are parallel and are intended to extend in a plane substantially parallel to the door, this such that a tilting of the operating element brings about a movement of the push part, which movement of the push part brings about a movement of the bolt; and
wherein the device further comprises a housing, which housing is intended for insertion into a recess in the door, wherein the fixed shaft is fixedly mounted in the housing and the second shaft is mounted for movement in a guide in the housing.

13. Device as claimed in claim 12, wherein each operating element takes the form of a flap suspended pivotally on one side from the housing, which flap extends in a plane substantially parallel to the fixed shaft and the first and second shafts.

14. Device as claimed claim 12, wherein the at least one operating element comprises a first operating element and a second operating element, which operating elements extend on either side of the coupling and are intended to be built into opposite sides of the door.

15. Device as claimed in claim 14, wherein the first operating element is tiltable around a first tilting shaft and wherein the second operating element is tiltable around a second tilting shaft parallel to the first tilting shaft, the first and second tilting shafts being spring-mounted relative to each other, this such that these tilting shafts are movable toward each other during placing of the device in the door and can move with spring action away from each other for the purpose of positioning the device in the door.

16. Device as claimed in claim 14, wherein the first and the second operating element are each connected by means of a spring-mounted arm to the housing.

17. Device as claimed in claim 16, wherein each spring-mounted arm is connected to a second fixed shaft which is parallel to the fixed shaft around which the pair of scissor arms rotates.

18. Device as claimed in claim 12, wherein the scissor arms are spring-mounted relative to each other such that the spring action moves the scissor arms away from each other.

19. Door comprising a device for locking a door, comprising:
at least one operating element which is intended to be accessible to a user for the purpose of opening the door and which is mounted tiltably relative to the door;
a bolt movable between a locking position and an opening position of the door;
a coupling which can be placed in the door and which is coupled between the bolt and the operating element for causing a movement of the bolt from the locking position to the opening position upon activation of an operating element of the at least one operating element, wherein the coupling comprises a pair of scissor arms mounted rotatably around a fixed shaft, and a pair of pivot arms, wherein each pivot arm is connected at a first end for pivoting around a respective first shaft to a respective scissor arm and connected at a second end for pivoting around a second shaft to a push part intended to engage against the bolt, which fixed shaft and first and second shafts are parallel and are intended to extend in a plane substantially parallel to the door, this such that a tilting of the operating element brings about a movement of the push part, which movement of the push part brings about a movement of the bolt.

20. Door as claimed in claim 19, wherein the bolt is mounted for tilting between a locking position and an opening position in the door around a transverse shaft oriented perpendicularly of the door.
